(19) United States
(12) Patent Application Publication
(10) Pub. No.: US 2024/0362794 A1
(43) Pub. Date: Oct. 31, 2024

(54) METHODS AND MECHANISMS FOR MANAGEMENT AND VISUALIZATION OF FINANCIAL TRANSACTION RELATED DATA

(71) Applicant: Abukai, Inc., San Francisco, CA (US)

(72) Inventors: Philipp Schloter, San Francisco, CA (US); Matthias Jacob, Bad Tolz (DE)

(21) Appl. No.: 18/644,814

(22) Filed: Apr. 24, 2024

Related U.S. Application Data
(60) Provisional application No. 63/462,474, filed on Apr. 27, 2023.

(51) Int. Cl. G06T 7/194; G06T 5/50; G06V 10/24

(52) U.S. Cl. CPC G06T 7/194; G06T 5/50; G06V 10/24; G06T 2207/20132; G06T 2207/20221; G06V 2201/07

(57) ABSTRACT

A system configured to obtain, by a processor, a data stream from a camera of a client device and identifying an object in the data stream. One or more operations are performed to crop the object from background data of the data stream. On a user interface of the client device, a cropped version of the object is then presented.

### RELATED APPLICATION

This application claims the benefit of U.S. Provisional Application No. 63/462,474, filed Apr. 27, 2023, the entire content of which is hereby incorporated by reference.

### TECHNICAL FIELD

The present disclosure relates to methods and mechanisms for the management and visualization of financial transaction related data. More specifically, the present disclosure relates to methods and mechanisms for real-time cropping, correction, and visualization of receipts, invoices and/or other documents and related data.

### BACKGROUND

Companies and businesses typically have their employees personally pay for business related expenses and will reimburse the employee for their expenses at a later time. Expense reports are generally used to track the time, date, amount, vendor, service provider, location, currency, and/or other information associated with these expenses. Often, employees spend a significant amount of time creating these expense reports due to employees needing to collect and save the physical receipts while ensuring they do not lose them prior to completion of their expense report.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a computer system is configured to obtain a data stream from a camera of a client device and identifying an object in the data stream. The computer system performs one or more operations to crop the object from background data of the data stream. On a user interface of the client device, a cropped version of the object is presented by the computer system.

A further aspect of the disclosure includes a method according to any aspect or implementation described herein.

A further aspect of the disclosure includes a non-transitory computer-readable storage medium comprising instructions that, when executed by a processing device operatively coupled to a memory, performs operations according to any aspect or implementation described herein.

### BRIEF DESCRIPTION OF THE DRAWINGS

The present disclosure is illustrated by way of example, and not by way of limitation in the figures of the accompanying drawings.

FIG. 1 is a block diagram illustrating an example computer system architecture, according to aspects of the present disclosure.

FIG. 2 depicts a block diagram illustrating an expense manager that includes software for providing expense management services for a client device, according to aspects of the present disclosure.

FIGS. 3A-3D are flow charts of methods for implementing crop detection and stabilization criteria, according to aspects of the present disclosure.

FIG. 4 is an example user interface implementing depth-based cropping techniques, according to aspects of the present disclosure.

FIG. 5 is an example user interface displaying a cropped receipt, according to aspects of the present disclosure.

FIG. 6 is an example user interface displaying a cropped receipt with an overlay of select data, according to aspects of the present disclosure.

FIG. 7 is another example user interface displaying a cropped receipt with an overlay of select data, according to aspects of the present disclosure.

FIG. 8 is another example user interface displaying a cropped receipt with an overlay of select data, according to aspects of the present disclosure.

FIG. 9 is another example user interface displaying a cropped receipt with an overlay of select data, according to aspects of the present disclosure.

FIG. 10 is another example user interface displaying a cropped receipt with an overlay of select data, according to aspects of the present disclosure.

FIG. 11 is another example user interface displaying a cropped receipt with an overlay of select data, according to aspects of the present disclosure.

FIG. 12 is another example user interface displaying a cropped receipt with an overlay of select data, according to aspects of the present disclosure.

FIG. 13 is an example showing a perspective correction applied using a projection with translation of the source image, according to aspects of the present disclosure.

FIG. 14 is a flow chart of a method for cropping and presenting an object, according to aspects of the present disclosure.

FIG. 15 is a block diagram illustrating a computer system, according to aspects of the present disclosure.

### DETAILED DESCRIPTION

Described herein are technologies directed to methods and mechanisms for real-time management and visualization of financial transaction related data. In current systems, employees manually enter a range of information from the receipt into a computer system, spreadsheet, device application, or online portal to complete an expense report. The employees can also be required to categorize the receipts manually (e.g., receipt for dinner, etc.), converts the currencies on the receipts to local currencies on the expense report, and submit physical copies of the receipts with the expense report. Even after all of the employee's work, a third person (e.g., in finance or accounting) typically verifies whether the information on receipts has been entered correctly by the employees and whether the proper category for each expense was elected.

In some instances, invoices and receipts may need to get digitized for archiving purposes. However, taking a photo of an invoice or receipt can make the resulting image appear skewed or distorted rather than as a “photocopy” having a top view (e.g., such as when viewed from a copy machine). For example, a photo of a receipt does not consider the size of the receipt while a physical photocopy replicates a receipt based on the original physical size of the document being photocopied. In addition, the photo often has a different color representation and can contain background that does not belong to the receipt, invoice or other document itself.

Certain software systems can manually remove the background, by, for example, selecting the four corners of a document and cropping out the document from the photo. However, this approach tends to be a tedious process which requires manual intervention by a user. Other systems can generate automatic cropping suggestions. However, these automatic suggestions of a possible area to crop from a photo often fail if the background has certain elements (referred to as a “busy background”) that confuse the cropping algorithm.

Aspects and implementations of the present disclosure address these and other shortcomings of the existing technology by enabling a system to provide a real-time preview of a cropped object from photos with any type of background, including busy backgrounds. In particular, the present system is configured to detect an object presented to a camera of a client device and to emulate a photocopy view (e.g., a top view of the object such as when viewed from a copy machine rather than a photo). In contrast to other methods to crop documents based on pinpoints, the present system can display a cropped object (e.g., a document, receipt, invoice, etc.) in real-time while pointing the camera at the object. To achieve this, the present system implements one or more operations (such as, for example, shape-based cropping and/or depth-based cropping) to stabilize the object while removing the background.

Aspects of the present disclosure result in technological advantages of enabling a handheld client device (e.g., a smartphone) to perform real-time document cropping and correction during the scanning of documents, invoices, receipts and so forth. In addition, the technological advantages of the present disclosure enable the client device to show a preview of the cropped result in real-time.

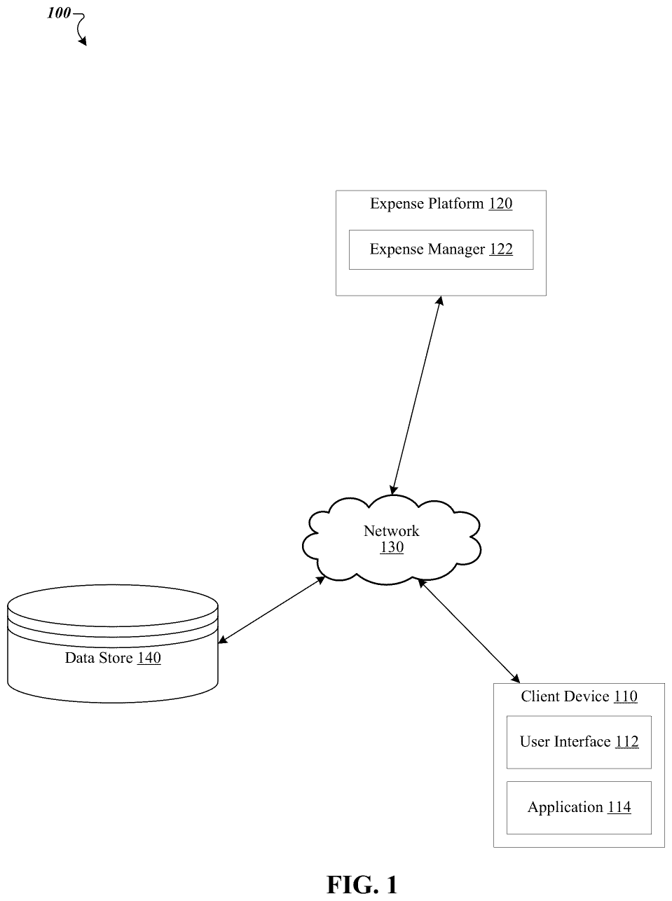

FIG. 1 depicts an illustrative computer system architecture 100, according to aspects of the present disclosure. Computer system architecture 100 includes client device 110, expense platform 120, and data store 140 communicably connected over network 130. Network 130 can be a private network (e.g., a local area network (LAN), a wide area network (WAN), intranet, etc.) or a public network (e.g., the Internet).

Client device 110 can include a computing device such as personal computers (PCs), laptops, mobile phones, smart phones, tablet computers, netbook computers, network connected televisions (“smart TVs”), network-connected media players (e.g., Blu-ray player), a set-top box, over-the-top (OTT) streaming devices, operator boxes, a personal digital assistant (PDA), etc. Client device 110 can include user interface (UI) 112 and application 114.

Application 114 can be a computer program configured to access expense management services. Expense management services can include services related to performing real-time (or near-real time, using stored data, etc.) cropping, correction, and visualization of object. In some implementations, the object can include a financial document, such as a receipt, an invoice, a contract, a legal agreement, or other form of documents. Each financial document can consist of a single page or multiple pages. In other implementations, the objects can include other physical object that can display or contain certain information, such as, for example, odometers, displays (gas station displays, cash register displays, etc.), and so forth. Although implementations herein will be discussed with references to financial documents, it is noted that computer system architecture 100 can be used to with any type of object.

In some implementations, application 114 can be hosted by expense platform 120. In other implementations, application 114 can be a local application stored and executed on client device 110. In some implementations, application 114 can implemented by one or more processes running on client device 110 to provide access to the expense management services provided by expense platform 120. Expense platform 120 can include expense manager 122, which can be a software component that enables expense platform 120 to manage, process, and provide visualization of financial transaction related data.

Alternatively, application 114 can operate and perform all (or certain) of the expense management services performed by expense platform 120 locally (e.g., without communication with expense platform 120). That is, application 114 can be a standalone application that is configured and/or licensed to run on a single device without using a network). In such implementations, software related to expense platform 120 (e.g., expense manager 122) can be stored on client device 110 (not shown).

User interface component 112 can receive user input (e.g., via a Graphical User Interface (GUI) displayed via client device 110) related to application 114. In some implementations, user interface 112 can be presented via a web browser (not shown) and application 114 can be hosted on expense platform 120. Alternatively, client device 110 includes a local (mobile or desktop) application 114 that provides user interface component 112. In some implementations, user interface 112 can communicate with the application 114 via network 130.

In some implementations, client device 110 can include one or more image capture devices (e.g., a camera) to capture images, generate video data, or generate a video stream or data stream (e.g., obtain data from the camera but not store the data on an internal or external memory device). In an example, the video stream can be generated by executing a camera application on the client device without enabling the record function. This allows a user to view a camera view on client device 110, which can be sent (e.g., transmitted) to expense manager 112. In some implementations, the image capture device can be an internal device of client device 110 (e.g., a build-in hardware component), an external device connected to client device 110 (e.g., a wired camera, a wireless camera, etc.), or any combination thereof.

In some implementations, client device 110 can include one or more depth capture devices to determine a depth value between client device 110 and an object (e.g., a financial document) held in front of client device 110. The depth capture devices can include, for example, a depth camera, a depth sensor, lidar, photogrammetry, IR projection, laser scanner or any other measurement tool configured to obtain or generate depth information. In some implementations, the depth capture device(s) can be an internal device of client device 110 (e.g., a build-in hardware component), an external device connected to client device 110 (e.g., a wired measurement tool, a wireless measurement tool, etc.), or any combination thereof.

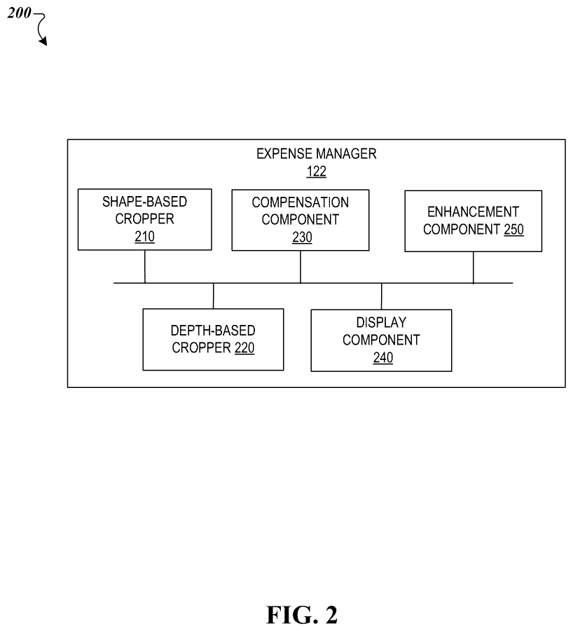

Expense platform 120 can be software or hardware capable of providing expense management services, via expense manager 122, to client device 110. Expense manager 122 will be discussed in detail below with regards to FIG. 2. Expense platform 120 can include one or more computing devices (such as a server, a workstation, a personal computer (PC), a mobile phone, a smart phone, a mobile computing device, a personal digital assistant (PDA), tablet, laptop computer, thin client.) storage devices (e.g., hard disks, databases), networks, software components, or hardware components. Expense platform 120 can include a website (e.g., a webpage), an interface, an application, or any other software capable of providing a user with access to the expense management services.

Client device 110, expense platform 120, and data store 140 can be coupled to each other via a network 130. In some implementations, network 130 is a public network that provides client device 110 with access to expense platform 120, and data store 140, and other publicly available computing devices. In some implementations, network 130 is a private network that provides client device 110 access to expense platform 120, data store 140, and other privately available computing devices. Network 130 can include one or more wide area networks (WANs), local area networks (LANs), wired networks (e.g., Ethernet network), wireless networks (e.g., an 802.11 network or a Wi-Fi network), cellular networks (e.g., a Long-Term Evolution (LTE) network), routers, hubs, switches, server computers, cloud computing networks, and/or a combination thereof.

Data store 140 can be a memory (e.g., random access memory), a drive (e.g., a hard drive, a flash drive), a database system, or another type of component or device capable of storing data. Data store 140 can include multiple storage components (e.g., multiple drives or multiple databases) that can span multiple computing devices (e.g., multiple server computers). The data store 140 can store data associated with the expense management services, such as, for example, processing financial transaction related data. In some implementations, data store 140 can store raw image data, processed data, etc. Raw image data can include any image data generated or obtained using client device 110 (e.g., via the camera, via an internal storage, via network 130, etc.). Processed data can include image data processed by expense manager 122, such as, for example, cropped images, corrected images, etc. In some implementations, one or more portions of data stored at data store 140 can be encrypted using an encryption mechanism (e.g., data is encrypted using a private encryption key). In other or similar implementations, data store 140 can include multiple data stores where data that is inaccessible to the user is stored in one or more first data stores and data that is accessible to the user is stored in one or more second data stores.

In some implementations, a “user” can be represented as a single individual. However, other implementations of the disclosure encompass a “user” being an entity controlled by a plurality of users and/or an automated source. For example, a set of individual users federated as a group of administrators can be considered a “user.”

FIG. 2 depicts a block diagram illustrating expense manager 122 that includes software for providing expense management services for a client device, in accordance with one or more aspects of the present disclosure. Expense manager 122 can include shape-based cropper 220, depth-based cropper 230, compensation component 230, display component 240, and enhancement component 250. The operations of the components 210-250 discussed herein can be performed by any portion of expense manager 122, application 114 of FIG. 1, other portions of a computing system, or any combination thereof. More or less components can be included without loss of generality. For example, two or more of the component of expense manager 122 can be combined into a single component or features of a component cab be divided into two or more components. In some implementation, one or more of the components can reside on different computing devices (e.g., a client device and a server device).

Expense manager 122 can receive a video stream obtained from the camera of client device 110. For example, the camera of client device 110 can be directed towards a financial document and, via application 114, the video stream from the camera can be sent to expense manager 122. In other implementations, one or more images or videos can be received by expense manager 122 (e.g., via data store 140, for example) and processed in accordance with the implementations below.

In some implementations, expense manager 112 can use shape-based cropper to separate a financial document from a background. In particular, shape-based cropper 210 can identify a potential shape (from a set of frames) of a financial document using, for example, an algorithm, a computer vision model, or any other type of image recognition or identification software. Shape-based cropper 210 can then separate the shape (referred to as a “crop”) from a corresponding background. Each financial document can consist of a single page or multiple pages, and multiple pages can be scanned or observed one-by-one or all at once. For example, the average crop can be utilized across multiple pages or analyzed, and a consistent crop can be applied across all pages, a subsection of pages, or a different crop can be applied for individual pages, a set of pages, or all pages in the set.

In some instances, the detected shapes can be unstable (e.g., in the temporal sense) due to, for example, noise, camera shaking, changing background, etc. To stabilize the shape of the crop, shape-based cropper 210 can determine the changes of the shape such as the size or location within the image, the estimated size of a financial document (e.g., receipt) in pixels, the pixel area, physical financial document size, etc. By stabilizing the shape of the crop, expense manager 122 can provide a stable preview of a possible crop via UI 112.

If the size of the crop significantly changes between frames over time, this can indicate that there is a noisy shape reading, and shape-based cropper 210 can ignore those frames as “noise.” In some instances, shape-based cropper 210 can use a crop when the frame area is larger than the previous frame area or large than certain percentage, factor, or constant factor than the previous frame.

To confirm whether a candidate crop is acceptable to display via UI 112, shape-based cropper 210 can analyze a certain number of frames to determine whether the shape of the crop stays consistent. This number of frames can be computed in terms of the amount of time it takes to compute the cropping shape for a frame. In some implementations, the number of frames to be considered can be predetermined for certain devices and identified by the device type. The number of frames can be different across different devices, or also different in terms of the workload, processing availability, memory availability, etc. of a certain device (e.g., client device 110).

To determine an acceptable crop vs an unacceptable crop, shape-based cropper 210 can calculate the maximum area over the last n frames and, if the next frame has a larger area, the next frame is then considered a better crop. In some implementations, shape-based cropper 210 can determine the standard deviation of the last k frames with the new frame. If the deviation is over a given threshold, then the new frame is not considered as better crop, but an outlier.

In some implementations, shape-based cropper 210 can perform temporal stabilization by observing a set of n consecutive frames and determining if the set of frames fit area requirements. For example, if the given number of n consecutive frames that fit the area requirement satisfies a threshold criterion (e.g., is above a threshold value), shape-based cropper 210 can accept and display the crop, or consider the crop in the capturing of a still image or a preview.

If there are m consecutive frames that do not fit the area requirement, then the previously found candidate crop is dismissed again until there is a number of consecutive frames that fit the area requirement again. The number m can be a threshold variable that is equivalent to n, or also a value smaller or larger than n. For example, initial crop detection could be allowed quickly, while then changes are only allowed slowly.

In some implementation, small changes in area or position of crop can be allowed faster (with fewer consecutive frames) by shape-based cropper 210, while a larger change in area or position of the detected crop can require more frames to occur with a consistent result (within some margin of error). In some implementations, shape-based cropper 210 can calculate the deviation of a new crop from the previous crops, and not use the candidate crops for display until there are a certain number of crops similar to the new crop. For example, shape-based cropper 210 can determine a deviation by computing the sum of the absolute values of coordinates of each point of a shape minus the coordinates of each point of a pervious candidate crop. In another example, shape-based cropper 210 can compute deviation using correlation-based methods, methods correlating image pixels, etc. In some implementations, these different thresholds (such as m and n mentioned above) can depend on specific system hardware capabilities of a client device, such as camera, GPU or CPU and could get calibrated based on that hardware, or the threshold can be computed from a current performance criterion, such as time to finish a certain computation on the computing device or camera, temperature, CPU utilization, GPU utilization, or similar metrics.

Shape-based cropper 210 can utilize different crop-detection criterion to identify acceptable crops. In some implementations, shape-based cropper 210 can identify rectangular shapes for a crop. In particular, acceptable crops can be identified as those having four corners with relatively parallel lines, and the four interior angles could be in a certain specified range to be considered acceptable. Further, the crops can be defined within a minimum and/or maximum aspect ratio. In particular, maximum and/or minimum angles between lines can be considered to identify a shape and decide which type of rectangles are acceptable. In some implementations, a minimum and maximum allowed area or volume for the receipt can be defined (e.g., by user input) and/or pre-define (e.g., by firmware settings, by operator settings, etc.). For example, the allowed area or volume can include a % of image area, physical area such as cm², m², square footage, certain number of pixels, pixel area, and so forth. If the identified crop takes up less space than the minimum area or volume, shape-based cropper 210 will reject the crop for further display. Similarly, if the identified crop takes up more space than the maximum area or volume, shape-based cropper 210 will reject the crop.

In another implementation regarding crop-detection criterion, shape-based cropper 210 accommodates arbitrarily shaped crops on financial documents using one or more artificial intelligence and/or or machine learning/deep learning technologies. For example, a machine-learning model is trained and used by shape-based cropper 210 to infer or recognize crops or cropped shapes and find the location of the financial document. The machine learning model can be trained using, for example, a labeled data set of cropped images. In some implementations, other image recognition and computer vision techniques can be used to enhance the results such as sharpening or kernel-based operations.

In some implementations, to locate the shape of the financial document consistently, shape-based cropper 210 can compute depth data obtained from, for example, a depth capture device (e.g., a depth camera on client device 110 which is used to measure the distance to objects), computed from a camera image, etc. Shape-based cropper 210 can use the depth information to identify if an object is held closely to the camera, while other elements are considered background. Shape-based cropper 210 can determine a reasonable distance of objects held in front of client device 110, or and other imaging device coupled to or connected to (e.g., via a wired connection, via a wireless connection, etc.) client device 110. For example, a range of values could be accepted, or certain points in the depth or image information could be considered to provide a reference point and then to check if the cropped shape lies within a certain range or section of those reference points.

To update a crop as the image and/or depth information input changes or stays constant, shape-based cropper 210 can consider different thresholds to determine if to allow or reject a change in crop. For example, if the change in area of the cropped shape is too large, in some implementations, the frame can be ignored unless a certain number of frames are reached to confirm that this size shape is acceptable and does not represent a noisy shape. To determine if a crop shape is large relative to the current or a previous shape, a constant scale factor, a constant amount, a percent of pixels observed, a determination of the physical size of the receipt, the resolution of the image, the resolution of a camera, the resolution of a depth sensor image as well as other metadata can be used by shape-based cropper 210.

In instances of smaller changes in the crop shape, area of the crop, or other crop-related factors, shape-based cropper 210 can update the crop shape directly, or within a certain number of frames (which could be a different setting, or same setting as the number of frames to pass for an initial detection or to consider a larger change as described previously). Also, if no crop, crop shape, or shape is found, shape-based cropper 210 can wait for another numbers of frames, possibly a shorter time to re-identify a crop, or for a longer set of frames, to make sure that this crop shape or crop is truly not visible in the image and/or depth information anymore before no longer displaying or applying a certain crop.

Shape-based cropper 210 could utilize a lower number of frames for initial detection but use a higher number of frames to update a detection if the area has changed significantly. Another threshold can be used to define how many frames shape-based cropper 210 can allow without a detected crop before the crop is removed from the viewfinder or still image.

In some implementations, shape-based cropper 210 can crop particular data from a stream or a frame. For example, shape-based cropper 210 can generate a crop that isolates a gas station pump, display of a gas station, odometer, navigation system map, computer display, or similar information display. To isolate the particular data, shape-based cropper 210 can recognize particular shapes or designs, or implement a machine-learning model configured taught to recognize the shapes with training data. This approach allows expense manager 122 to highlight specific information without including possibly irrelevant background.

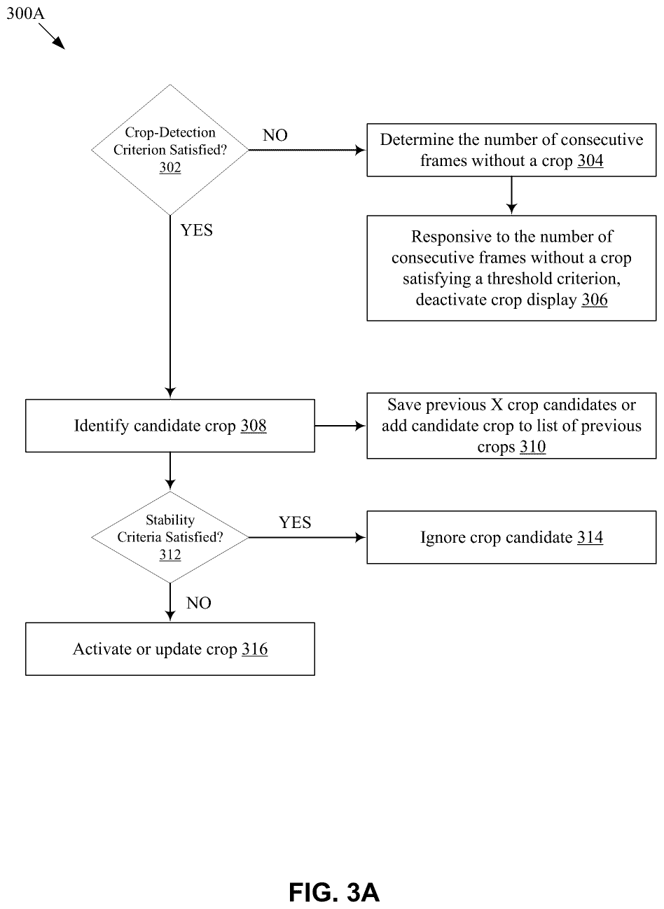

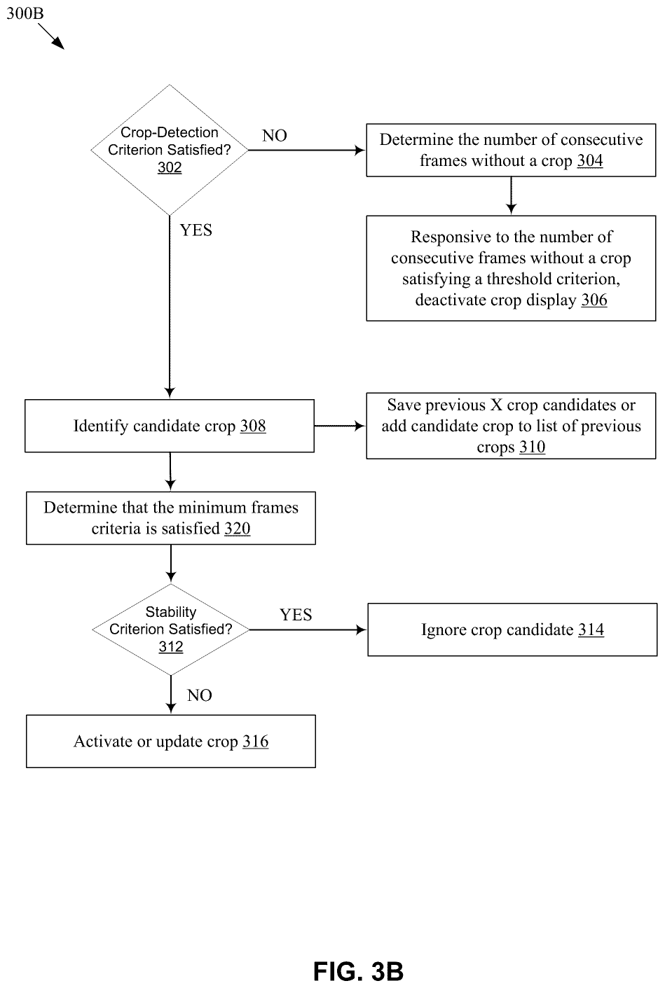

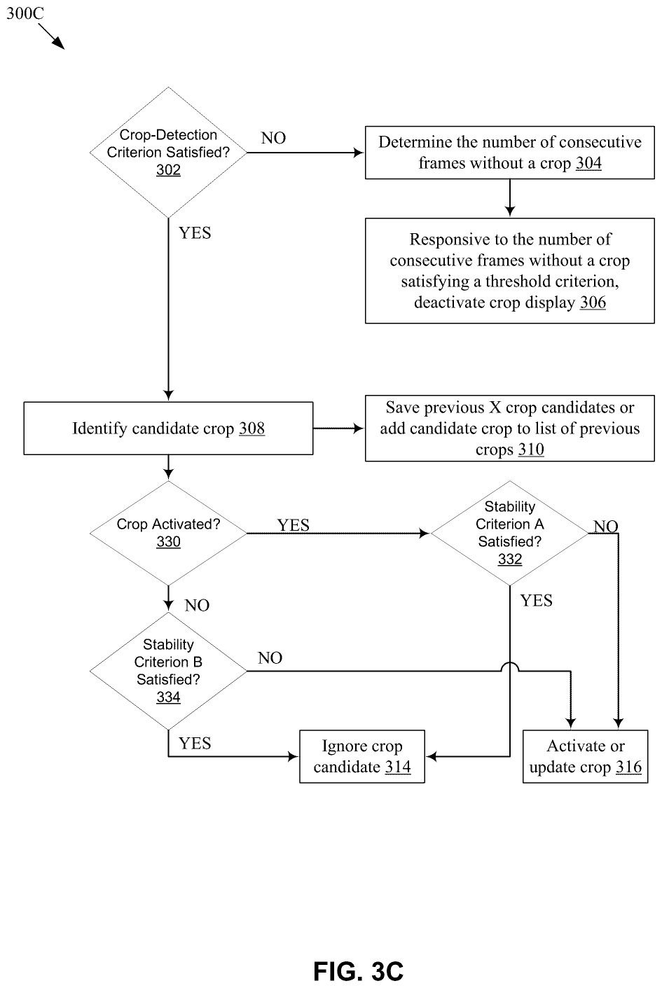

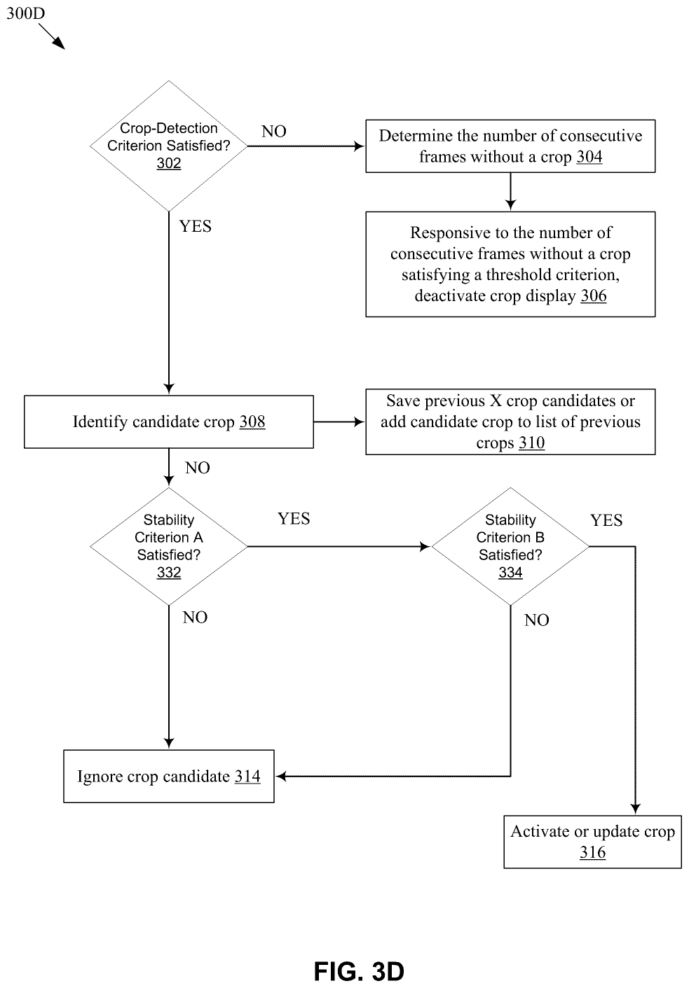

FIG. 3A is a flow chart of a method 300A for implementing crop detection and stabilization criteria, according to aspects of the present disclosure. Method 300A is performed by processing logic that can include hardware (circuitry, dedicated logic, etc.), software (such as is run on a general-purpose computer system or a dedicated machine), firmware, or some combination thereof. In one implementation, method 300A can be performed by a computer system, such as computer system architecture 100 of FIG. 1. In other or similar implementations, one or more operations of method 300A can be performed by one or more other machines not depicted in the figures. In some aspects, one or more operations of method 300A can be performed by client device 110 and/or expense platform 120.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 302, processing logic determines whether crop-detection criterion is satisfied. Responsive to the crop-detection criterion failing to be satisfied, the processing logic proceeds to operation 304. Responsive to the crop-detection criterion being satisfied, the processing logic proceeds to operation 308.

At operation 304, processing logic determines the number of consecutive frames without a crop.

At operation 306, responsive to the number of consecutive frames without a crop satisfying a threshold criterion, processing logic can deactivate the crop display (e.g., dismiss the crop). The threshold criterion can be the number of consecutive frames without a crop being greater than or equal to the number consecutive frames that do not fit the area requirement.

At operation 308, processing logic identifies a candidate crop.

At operation 310, processing logic saves the previous x number of crop candidates and/or adds the candidate crop to a list of previous crops.

At operation 312, processing logic determines whether a stability criterion is satisfied. In an example, the stability criterion can be satisfied when the area of the candidate crop multiplied by a predetermined value is greater than the maximum area over a predetermined number of previous frame crops. Responsive to the stability criterion being satisfied, the processing logic proceeds to operation 314 and ignores the crop candidate. Responsive to the stability criterion failing to be satisfied, the processing logic proceeds to operation 316 and activates or updates the crop to display the crop or an average number of previous crop candidates.

FIG. 3B is a flow chart of another method 300B for implementing crop detection and stabilization criteria, according to aspects of the present disclosure. Method 300B is performed by processing logic that can include hardware (circuitry, dedicated logic, etc.), software (such as is run on a general-purpose computer system or a dedicated machine), firmware, or some combination thereof. In one implementation, method 300B can be performed by a computer system, such as computer system architecture 100 of FIG. 1. In other or similar implementations, one or more operations of method 300B can be performed by one or more other machines not depicted in the figures. In some aspects, one or more operations of method 300B can be performed by client device 110 and/or expense platform 120.

Operations 302-310 can be similar to those performed in method 300A.

At operation 320, processing logic determines that the minimum frames criterion is satisfied for the candidate crop. To determine whether the minimum frames criterion is satisfied, if no crop is active, processing logic determines whether the number of frames since the last active crop is greater than a predetermined value.

Operations 312-316 can be similar to those performed in method 300A.

FIG. 3C is a flow chart of another method 300C for implementing crop detection and stabilization criteria, according to aspects of the present disclosure. Method 300C is performed by processing logic that can include hardware (circuitry, dedicated logic, etc.), software (such as is run on a general-purpose computer system or a dedicated machine), firmware, or some combination thereof. In one implementation, method 300C can be performed by a computer system, such as computer system architecture 100 of FIG. 1. In other or similar implementations, one or more operations of method 300C can be performed by one or more other machines not depicted in the figures. In some aspects, one or more operations of method 300C can be performed by client device 110 and/or expense platform 120.

Operations 302-310 can be similar to those performed in method 300A.

At operation 312, processing logic determines whether a crop is active already.

At operation 332, processing logic determines whether a first stability criterion is satisfied. The first stability criterion can be similar to the stability criterion of operation 312 in method 300. For example, the stability criterion can be satisfied when the area of the candidate crop multiplied by a predetermined value is greater than the maximum area over a predetermined number of previous frame crops. Responsive to the first stability criterion being satisfied, the processing logic proceeds to operation 314 and ignores the crop candidate. Responsive to the first stability criterion failing to be satisfied, the processing logic proceeds to operation 316 and activates or updates the crop to display the crop or an average number of previous crop candidates.

At operation 334, processing logic determines whether a second stability criterion is satisfied. For example, the second stability criterion can be satisfied when the area of the candidate crop multiplied by a different predetermined value (different from the first stability criterion) is greater than the maximum area over a different predetermined number of previous frame crops (different from the first stability criterion). Responsive to the second stability criterion being satisfied, the processing logic proceeds to operation 314 and ignores the crop candidate. Responsive to the second stability criterion failing to be satisfied, the processing logic proceeds to operation 316 and activates or updates the crop to display the crop or an average number of previous crop candidates.

FIG. 3D is a flow chart of another method 300D for implementing crop detection and stabilization criteria, according to aspects of the present disclosure. Method 300D is performed by processing logic that can include hardware (circuitry, dedicated logic, etc.), software (such as is run on a general-purpose computer system or a dedicated machine), firmware, or some combination thereof. In one implementation, method 300D can be performed by a computer system, such as computer system architecture 100 of FIG. 1. In other or similar implementations, one or more operations of method 300D can be performed by one or more other machines not depicted in the figures. In some aspects, one or more operations of method 300D can be performed by client device 110 and/or expense platform 120.

Operations 302-310 can be similar to those performed in method 300A.

At operation 332, processing logic determines whether a first stability criterion is satisfied. The first stability criterion can be similar to the stability criterion of operation 312 in method 300. For example, the stability criterion can be satisfied when the area of the candidate crop multiplied by a predetermined value is greater than the maximum area over a predetermined number of previous frame crops. Responsive to the first stability criterion being satisfied, the processing logic proceeds to operation 334. Responsive to the first stability criterion failing to be satisfied, the processing logic proceeds to operation 316 and activates or updates the crop to display the crop or an average number of previous crop candidates.

At operation 334, processing logic determines whether a second stability criterion is satisfied. For example, the second stability criterion can be satisfied when the area of the candidate crop multiplied by a different predetermined value (different from the first stability criterion) is greater than the maximum area over a different predetermined number of previous frame crops (different from the first stability criterion). Responsive to the second stability criterion being satisfied, the processing logic proceeds to operation 314 and ignores the crop candidate. Responsive to the second stability criterion failing to be satisfied, the processing logic proceeds to operation 316 and activates or updates the crop to display the crop or an average number of previous crop candidates.

In some implementations, operation 310 of methods 300A-300D can be performed using a trailed machine-learning model. In particular, processing logic can use a trained machine learning model to infer or detect a crop.

Returning to FIG. 2, depth-based cropper 220 can utilize depth information to determine the shape of financial documents held in front of the camera and separate the background from the financial documents. Depth information can be obtained using, for example, a depth capture device coupled or connected to client device 110. In some implementations, depth-based cropper 220 can be used in response to shape-based cropper 220 failing to determine a crop (due to, for example, a recognized shape not being identified or failing to separate a background). Alternatively, depth-based cropper 220 can be initially implemented (e.g., before resorting to shape-based cropper 210, if necessary), or any combination thereof.

In some implementations, depth-based cropper 220 can utilized a threshold value to determine an allowable depth and remove any objects, pixels, background, etc. behind the threshold (e.g., further away from the camera). In some implementations, depth-based cropper 220 can compute the threshold value based on the average depth of the object found (e.g., of the financial document found in the center of the image), by analyzing the image and finding objects of interest and then utilizing depth information from those objects, etc. The threshold can be adjusted on each camera frame, can be averaged over multiple frames to create a dynamic threshold for cut off, etc. The image data outside the threshold value can be blended out fully or can be blended gradually to indicate a transition to the object (e.g., the financial document). For example, depth-based cropper 220 can remove the background behind a gas station pump, the background of a stream of an odometer or navigation system in a car, etc. If now a new crop shape (such as rectangle, or other shapes, circles, etc.) is found, the depth can be switched off and the crop shape can be displayed, the depth crop can be combined with the shape-based cropping mechanism to better find or speed up the crop, etc.

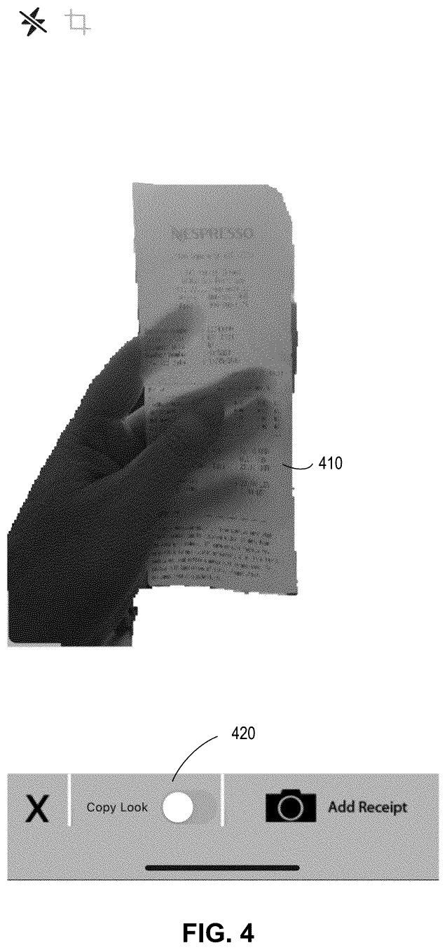

FIG. 4 is an example user interface implementing depth-based cropping techniques. As shown, candidate crop 410 displaying a receipt and hand are identified by depth-based cropper 220 and the background is removed due to being of a different depth. Once the candidate crop 410 is displayed, a user can select button 420 to save the candidate crop.

Compensation component 230 can identify floor or ceiling and filter the floor or ceiling out of the display. In particular, when pointing client device 110 towards an object, often part of the floor or ceiling might be visible, which might be closer to the camera than background as it connects where the user stands slowly to the background further away. For example, if a document is held 50 cm from the client device camera, there can be a floor or ceiling that is also quite close in relation to the image plane of the camera or a depth sensor. In this instance, compensation component 230 can identify floor or ceiling (or wall) through an algorithm and filter them out. In some implementations, compensation component 230 can assert that there is a certain floor gradient and exclude that image data from the image, unless an object is found. This way a floor or ceiling can be removed. The floor or ceiling likely has a gradual change in depth across the surface the further away it is from the sensor or camera while an object can have a more consistent depth value. These criteria can be implemented to also crop out the floor and ceiling even if the depth is below a certain threshold as previously identified. Alternatively, compensation component 230 can implement a machine learning or deep learning model to predict floor, ceiling or walls and filter those pixels out. Compensation component 230 can be used with or in addition to shape-based cropper 210 and/or depth-based cropper.

Display component 240 can provide the crop for display in UI 112 of client device 110. For example, display component 240 can provide the crop in a preview, viewfinder, camera feed, or other method in real-time or with a certain delay (e.g., near real-time) and update speed to show the user which elements were cropped. Display component 240 and/or UI 112 can provide the visualization of the crop by blending out parts of an image or showing a frame or coloring a certain part of the image such as the background e.g., with white, black, red, green, blue or another any color, or some kind of gradient, logo etc.

UI 112 could provide different options such as turning on/off the visualization of the crop, turning on/off the application of the crop, etc. In some implementations, UI 112 could provide an option (e.g., a button) to make the image preview appear as a still image. The button could be provided to exit out of an object capturing mode. Another button could provide the option to, for example, add a receipt, scan a document, add an invoice, etc., to trigger a still image capture of the previewed result visible. The viewfinder could show a real-time preview of the camera image, but with cropping and or the “copy look” applied or depending on the options selected other preview options. UI 112 can include another button or icon to turn on or off the recognition of key document data from the camera view. Another icon could turn on flash and/or lighting such as flash lamp or torch on or off or switch between flash, automatic flash if dark, or no flash.

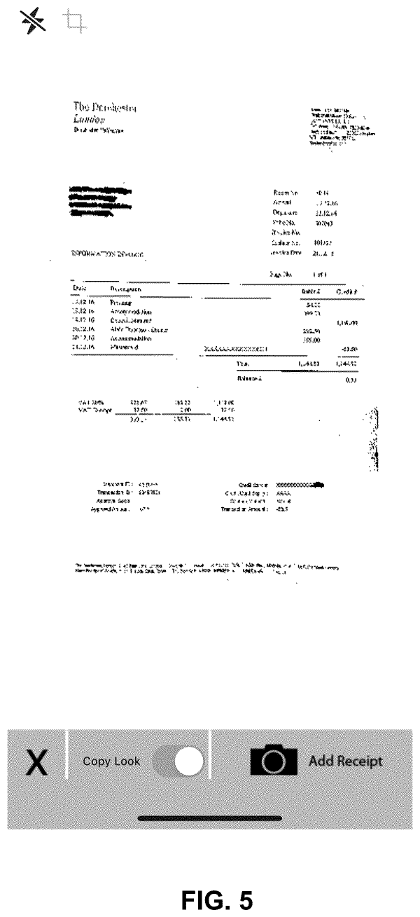

FIG. 5 is an example user interface displaying a cropped receipt. As shown, the cropped receipt is displayed as a top view with the background filtered out.

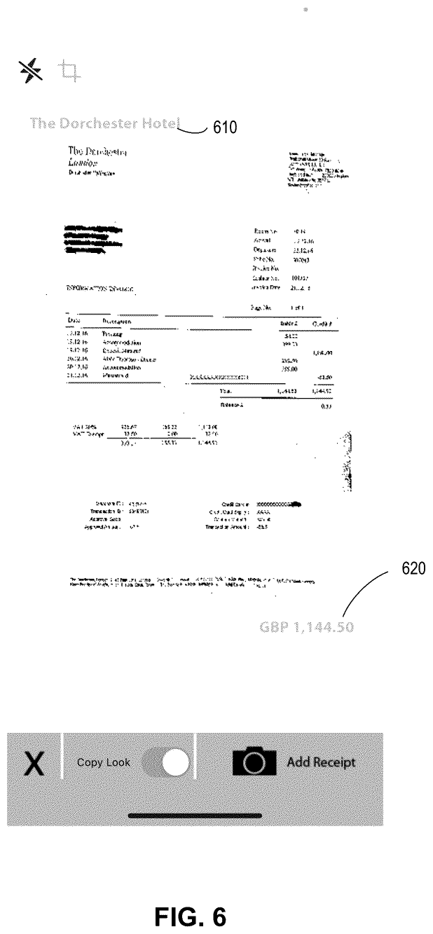

FIG. 6 is an example user interface displaying a cropped receipt with an overlay of select data. As shown, source of the receipt (e.g., The Dorchester Hotel) is shown as an overlay 610 and the total bill is shown as overlay 620.

Enhancements component 250 can provide visualization or enhancement of data or certain elements of an object (e.g., a financial document). In particular, when a crop is identified by cropper 210 and/or 220 or displayed by display component 240, enhancements component 250 could identify and display certain elements of the cropped object. For example, enhancements component 250 can display a vendor relevant to a receipt or invoice, a logo on the screen, or on the display in real-time over the viewfinder, or other UI elements, or after taking a still image. Such logos could be displayed as the background around the crop, or also laid over the crop. The logo could be animated, or e.g., change in size to showcase a detection expect. Other data such as vendor name, amount, dates, category of expense or purchase, general ledger information, GL code, expense category, unit, cost center, VAT amount, VAT %, sales tax amount, sales %, GST, HST or PST amount, GST, HST or PST %, currency, classifications such as breakfast vs. lunch vs. dinner, could also be visualized. In another example, enhancements component 250 could also visualize if any alcohol was consumed e.g., as part of a receipt or invoice from a restaurant, bar, grocery store, or any other document that lists certain types of beverages, spirits, drinks, or give any other indications of alcohol consumptions. Enhancements component 250 can itemize hotel invoices and brake them down into subcategorized such as but not limited to parking, lodging, taxes, meals and e.g., non-reimbursable hotel expenses can be flagged. Per-diem receipts for meals or hotel room rates per location can be visualized as well where not an actual receipt from a vendor is provided, but simply a form to illustrate that a certain entity provided fee is reimbursable given a certain travel pattern, location, amount, job grade or other information.

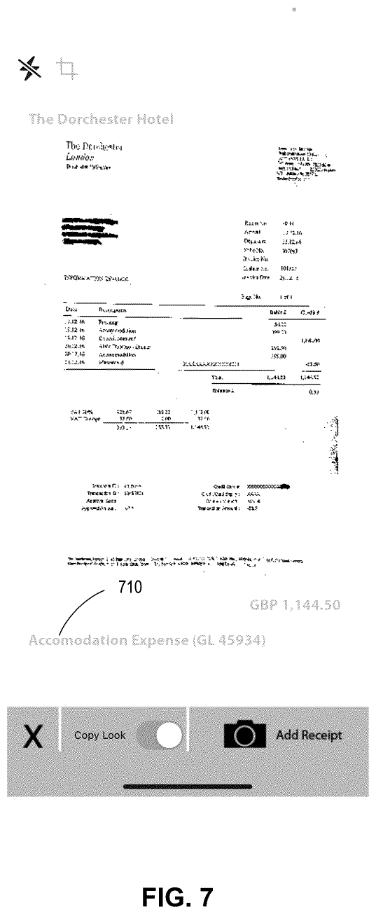

FIG. 7 is another example user interface displaying a cropped receipt with an overlay of select data. As shown, the cropped receipt of FIG. 6 further includes an overlay that illustrates a single category and GL code information 710.

In some implementations, enhancements component 250 can overlay text or graphics onto a crop. The text or graphics can be animated, for example, to illustrate when a new result or data or document element was recognized. Such visualization or animation could occur while previewing the cropped object (e.g., receipt, invoice, document, etc.), or while viewing the camera image without crop, or modification. In some implementations, the visualization could also include the amount converted to a home currency automatically while displaying the crop visualization. The home currency could be previously selected by the user or determined for example based on region settings of a mobile device or computing device, or a user profile previously created. The GPS, or other local or geographic positioning, coordinates or cell tower information can also be used to determine the region. The exchange rates to convert from the local recognized amount to the home amount can be looked up through a database on the computing device, a server, cloud infrastructure, web services, or also databases or tables hosted elsewhere. Based on the recognized date, invoice date, date of purchase or travel dates, or other dates, this conversion can happen automatically or with a certain delay, to then display the information in this visualization.

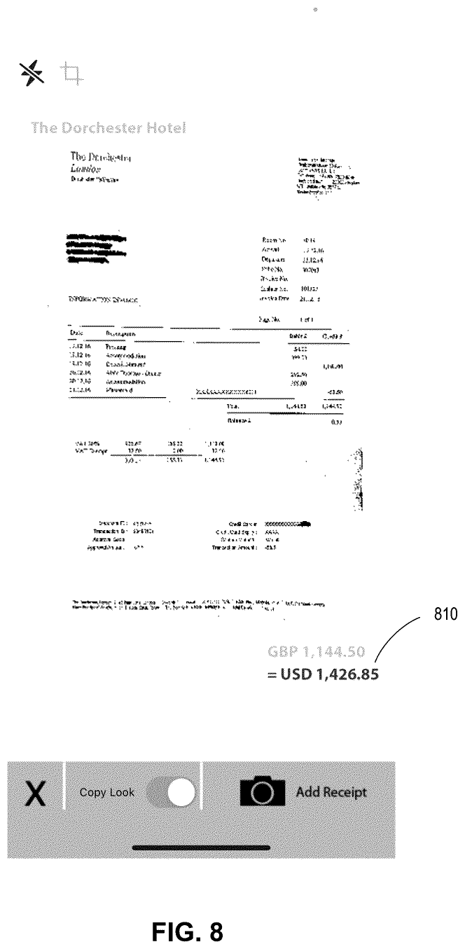

FIG. 8 is another example user interface displaying a cropped receipt with an overlay of select data. As shown, the cropped receipt of FIG. 7 further includes an overlay that illustrates a conversion 810 of the total price from GBP to USD.

In some implementations, enhancement component 250 can flag certain object (e.g., receipts, invoices, entire reports consisting of multiple invoices or receipts, etc.) to one or more other user (e.g., a supervisor) based on such attributes to visualize a deviation from a company policy or other form of rule, regulation, or policy.

In some implementations, enhancement component 250 can detect personal data in object such as, for example, the last 4 digits of a credit card, the type of bank, credit, debit or other card, the supplier or bank of the card. Enhancement component 250 can then display the personal data over the crop, as background to the crop, or another user interface element on the screen when pointing a camera or otherwise, display sensor or other device at an object (e.g., a receipt, an invoice, or other document). In some implementations, enhancement component 250 can automatically detected and visualized the type of document on top of the crop, as background to the crop, or another user interface element on the screen.

In some implementations, certain financial data such as credit card, bank, debit card, ATM card, other type of financial transactions could automatically be matched up (via enhancement component 250) with the data found on the receipt while displaying the crop or image preview from the camera. For example, an amount found on the receipt could automatically be compared against a set of candidate transactions and if the same or a similar amount is found, then data from that transaction could be displayed. A checkbox, card symbol, text, or other icon could be displayed to indicate possible deviations between what the receipt displays and what the financial transaction record states, for example, from a different data source. For example, enhancement component 250 could identify dates, vendor names, memos, amounts, home amounts, currencies, text, charge date, card numbers, category of expense, vendor, and other data to identify one or more possible matches out of the candidate transactions. If a vendor text matches or looks similar to data provided in the card memo or a transaction vendor, enhancement component 250 can identify a possible match. In some instances, the date in the transaction is a future data from the invoice or receipt while the amount matches and is in the same currency. This type of match could be displayed or visualized as a date deviation. For example, by highlighting the data with a color such as yellow or displaying a certain icon to illustrate a date deviation. A text could be displayed as well or instead.

Similarly, if a vendor matches and the date matches, but amount is different, enhancement component 250 can display or visualize a match as amount deviation. For example, by highlighting the data with another color such as red or displaying a certain icon to illustrate an amount deviation. A text could be displayed as well or instead. Similarly, if the amount matches and the date matches, but the vendor or memo string is different enough, a match could be displayed or visualized as vendor name deviation. For example, by highlighting the data with another color such as orange, or also the same color e.g., yellow, or displaying a certain icon to illustrate a vendor deviation. A text could be displayed as well or instead. If the amount, date and vendor match, a “perfect” match could be displayed or visualized. For example, by highlighting the data with another color such as green or silver, or also the same color, or displaying a certain icon to illustrate such good match. A text could be displayed as well or instead. Based on perfect match, certain other actions can be triggered by enhancement component 250, such as automatically skipping certain approval steps, automatically getting marked as verified, etc.

A date match could also follow certain criteria such as e.g., minus 1 day to plus 4 days as a good date match, while anything over 4 days but below 10 days is a semi-good date match that could be accordingly visualized. If a date from the recognized expense, invoice or document, is both outside the “good date” range and “semi-good date” range, it could then be rejected as a date match. Often card transactions can get charged later and not on time, so applying such operations can be important to identify and visualize matches.

A vendor match can take place with a database of strings or transaction memos that match certain vendors. As well as possible anti-vendors that never match a specific string. So, for example, if enhancement component 250 identifies a substring in a transaction memo or vendor field for a transaction that is on the anti-vendor list, that relates or matches to a vendor that is recognized from the receipt, invoice or document, the transaction could be immediately flagged as not a vendor match. Also, a path to correct certain vendor typing to correct vendors could be applied as an operation by enhancement component 250. In addition, legal formations indicators such as Inc., Ltd., LLC, etc. could be removed in an operation to further standardize potential spelling of vendors for consistency.

An amount match could take place when an amount for a transaction match exactly the amount recognized on a receipt as total, subtotal or similar partial amount, depending on the configuration and what is needed. In some implementations, the currency can get considered so that, for example, an amount that is within the range of the recognized amount converted to the home currency still is considered a match. For example, an upper and lower bound could be applied such as −2% and +2.5% or different values or even absolute values. If the converted amount in the home currency (applying the exchange rate found for the given date, or date range) matches up with the transaction amount in the home currency, in the sense that it lies within that range, enhancement component 250 can identify an amount match. This amount match that was within a certain “foreign exchange” range could be visualized e.g., with an FX symbol, currency symbol or other icon to highlight that an amount match occurred but only due to a fuzzy factor in the amount.

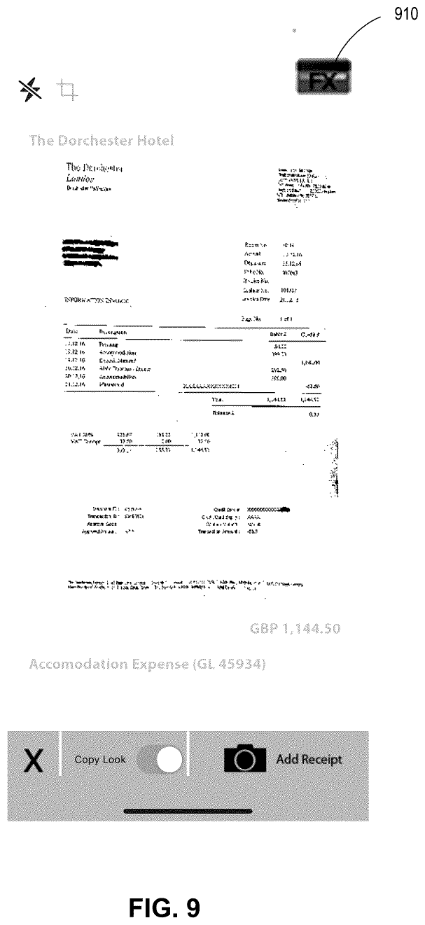

FIG. 9 is another example user interface displaying a cropped receipt with an overlay of select data. As shown, the cropped receipt of FIG. 7 further includes an overlay that illustrates a visualization 910 of match type (FX for foreign exchange-based amount match).

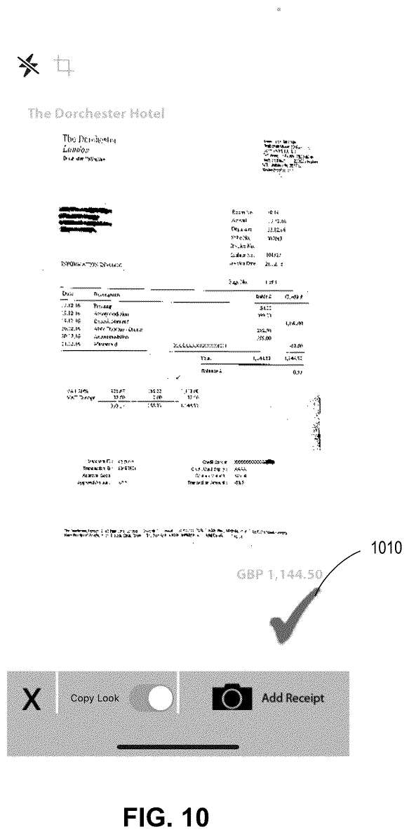

FIG. 10 is another example user interface displaying a cropped receipt with an overlay of select data. As shown, the cropped receipt of FIG. 7 further includes an overlay that illustrates a visualization 1010 of a perfect or good match.

Visualizations and overlays that apply or were displayed on the preview could also be applied, displayed or overlaid (by enhancement component 250) over a still image, for example, with the cropped receipt, invoice or document. The crop from the preview can also be displayed on the resulting still image, as it was visible in the preview. In some implementations, the resulting still image crop could show the document in colors with or without crop, or for example darken the background outside of the crop or show a certain color for the cropped. The cropped still image can later be embedded, by enhancement component 250, in other documents such as PDF, Word DOC, Excel XLS etc. for further use. A moving image recorded when cropping the receipt could also be played backed in other documents.

In some implementations, enhancement component 250 can perform one or more operations to update the crop. In particular, taking a still picture, photo or screenshot can result in utilizing the already computed crop area and scaling it up, or in computing a new crop based on the still image or other previous images taken or viewfinder images received. Depth information can be considered as well. The visualization for the still image can differentiate from the viewfinder or preview visualization or it can look the same or similar. The visualization of the crop in the still image can also be done by blending out parts of an image or showing a frame or coloring a certain part of the image such as the background e.g., with white, black, red, green, blue or another any color, or some kind of gradient, logo etc.

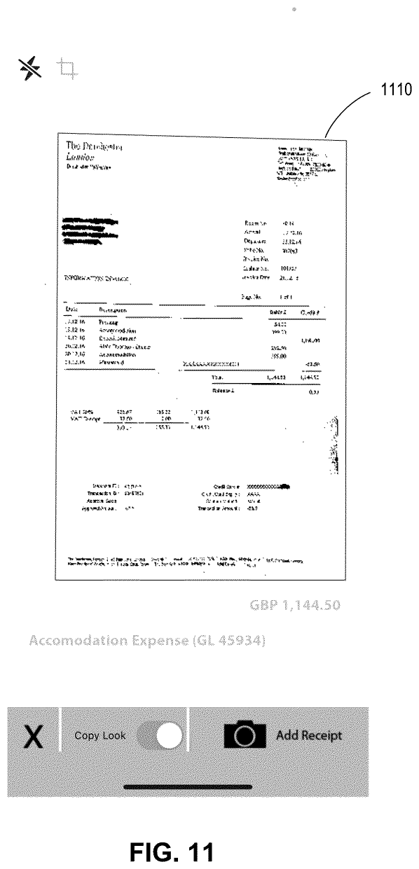

FIG. 11 is another example user interface displaying a cropped receipt with an overlay of select data. As shown, the cropped receipt of FIG. 7 further includes a overlay of a frame 1110 to illustrate the receipt.

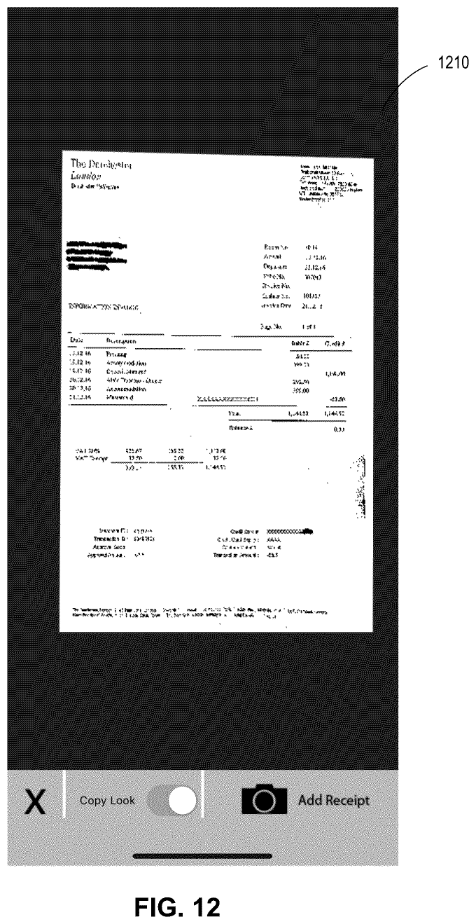

FIG. 12 is another example user interface displaying a cropped receipt with an overlay of select data. As shown, the cropped receipt of FIG. 7 further includes a background 1210 outside of the overlay of the frame 1110.

In some implementations, enhancement component 250 can perform copy scan effect operations. In particular, (optionally combined with the copy scanning technology), enhancement component 250 can determine the real-world size and aspect ratio for further layout in reports, documents, websites, or other forms of media. For example, to enhancement component 250 can fit multiple images on the same page or place a single image on a page. This could take place, for example, when displaying a website, outputting a word document, a PDF, or Excel file, or any other file, document or report with any kind of technology or network.

In some implementations, enhancement component 250 can perform perspective correction operations to use perspective control or perspective correction to straighten the financial document. For example, while viewing the preview receipts, the cropped shape can get automatically be prospectively corrected. If the receipt was taken from a certain angle instead of parallel to the receipt, it gets corrected to fit a rectangular shape (e.g., the image could be stretched to fill a whole image or a certain rectangle rather than a certain shape).

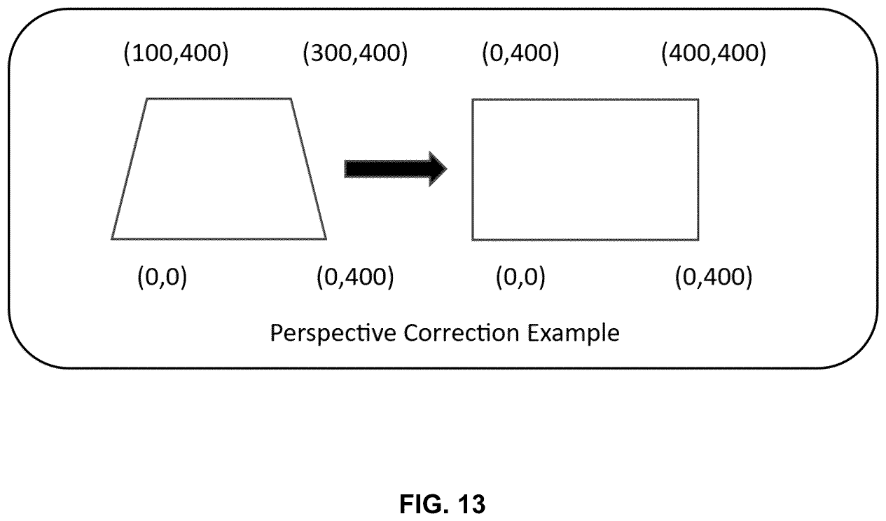

For example, given a tilted object (e.g., receipt), a perspective correction can be applied using, for example, a projection with translation of the source image, as shown in FIG. 13. In an example, a destination point can be represented as

$$\begin{matrix}A \\ {P}^{⋀} T\end{matrix} \begin{matrix}t \\ 1\end{matrix} *$$

source point. In the case shown in FIG. 13,

$$A = \begin{matrix}2 \\ 0\end{matrix} \begin{matrix}- 0.5 \\ 2\end{matrix} , t = [ - 400 , 0 ] ,$$

and P=[0,0.01]. In this implementation, in real-time, a corrected perspective receipt, invoice or document is displayed and the resulting image can be displayed by rendering, for example, a polygon with the new vertices computed based on the destination points, from the original source points.

In another implementation, the receipt, invoice or other document only gets prospectively corrected once a still image is taken. This perspective correction can be performed by enhancement component 250 after the picture was taken.

In another implementation, a receipt, invoice or other document can get perspective-corrected while enhancement component 250 takes into account the relative size of the receipt, invoice or document, or paper format for later use (for example to get laid out correctly on a PDF, word document, website, application, mobile application, or other summary documentation).

In yet another implementation, a receipt, invoice or other document can get perspective-corrected but get adjusted visually and placed inside the image to reflect a realistic size estimation of the documentation in comparison to the overall image. For example, a small coffee receipt might take up a smaller space in the resulting image, then for example a full letter or A4 format hotel bill. Based on knowledge of the type of receipt, depth sensing, image analysis and other contextual information, enhancement component 250 can estimate the receipt size and make such placement decisions.

In some implementations, enhancement component 250 can apply the crop to existing images. In particular, enhancement component 250 can crop existing images such as JPEG, PNG, TIFF etc. These existing images could be imported from data store 140, client device 110, an external device, from a file browser through a web page, etc., or the images can be emailed or imported in other ways to the client device 110 or expense platform 120. In this case, some operations such as temporal stabilization cannot be applied. Enhancement component 250 reads the source image, and the cropped and perspective-corrected image is written out. A single image could also contain various visualizations and overlays as mentioned above. The single image could also be modified visually for example with the copy-scan type effect (as described above). The image can optionally get perspective corrected (as described above). Documents with multiple pages could be converted into a single image file or multiple image, and similar methods could be applied.

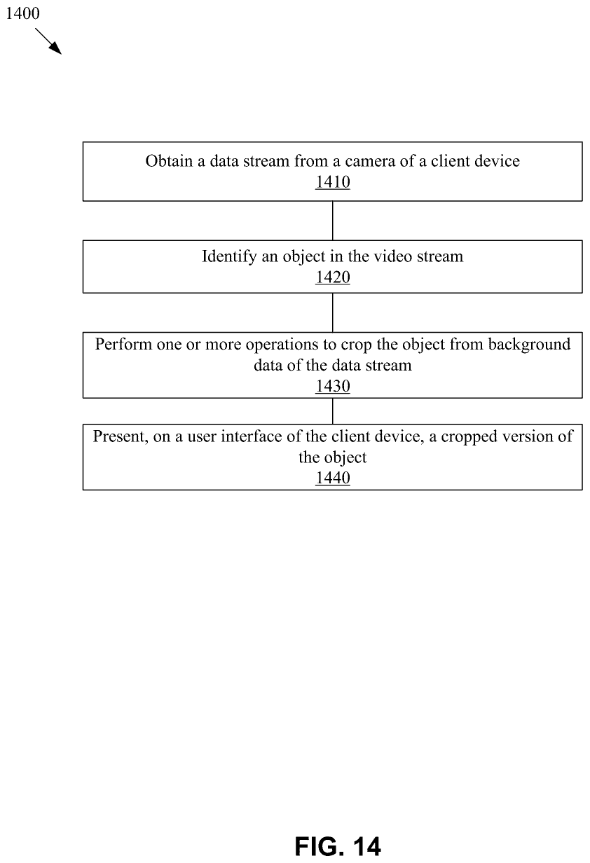

FIG. 14 is a flow chart of a method 1400 for cropping and presenting an object, according to aspects of the present disclosure. Method 1400 is performed by processing logic that can include hardware (circuitry, dedicated logic, etc.), software (such as is run on a general-purpose computer system or a dedicated machine), firmware, or some combination thereof. In one implementation, method 1400 can be performed by a computer system, such as computer system architecture 100 of FIG. 1. In other or similar implementations, one or more operations of method 1400 can be performed by one or more other machines not depicted in the figures. In some aspects, one or more operations of method 1400 can be performed by client device 110 and/or expense platform 120.

At operation 1410, processing logic obtains a data stream from a camera of a client device. The data stream can be a video stream.

At operation 1420, processing logic identifies an object in the video stream. The object can be identified using, for example, one or more of the techniques discussed in FIG. 2, using a machine-learning model, etc. The object can include financial documents such as a receipt, an invoice, a document, etc., or objects such as, for example, a gas station pump, display of a gas station, odometer, navigation system map, computer display, etc.

At operation 1430, processing logic performs one or more operations to crop the object from background data of the data stream. The object can be identified using, for example, one or more of the shape-base or depth-based techniques discussed in FIG. 2.

At operation 1440, processing logic presents, on a user interface of the client device, a cropped version of the object. In some implementation, processing logic can perform one or more operations to change an orientation of the cropped version of the object to, for example, a top view. In some implementations, the processing logic can display an overlay on the cropped version of the object (the overlay can data identified based on the object, such as, logos, sums, currency conversions, etc.). The cropped version of the object can be presented in real time or near real time.

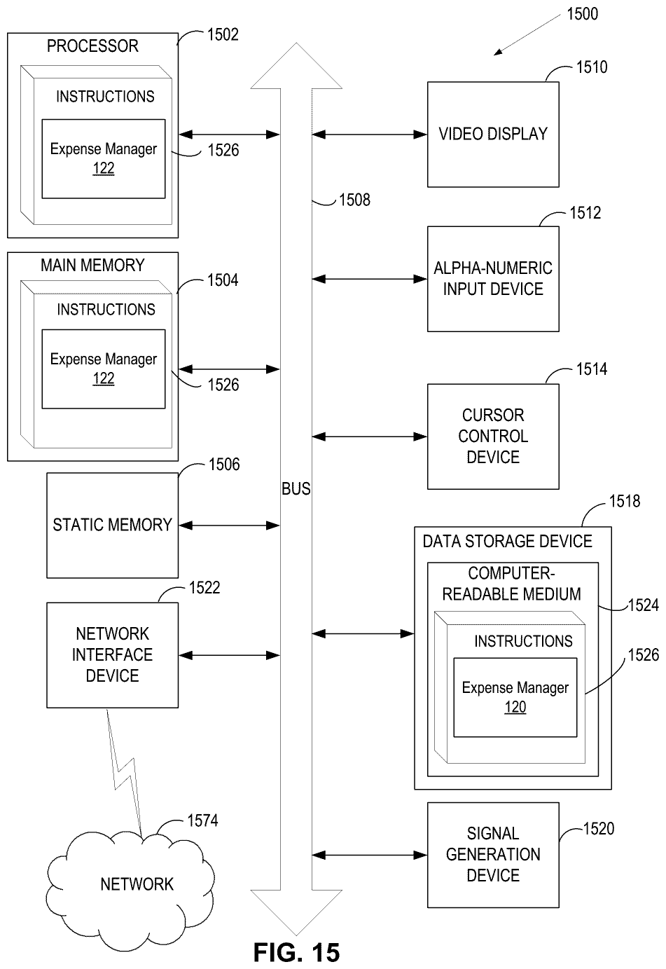

FIG. 15 is a block diagram illustrating a computer system 1500, according to certain implementations. In some implementations, computer system 1500 can be connected (e.g., via a network, such as a Local Area Network (LAN), an intranet, an extranet, or the Internet) to other computer systems. Computer system 1500 can operate in the capacity of a server or a client computer in a client-server environment, or as a peer computer in a peer-to-peer or distributed network environment. Computer system 1500 can be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1500 can include a processing device 1502, a volatile memory 1504 (e.g., Random Access Memory (RAM)), a non-volatile memory 1506 (e.g., Read-Only Memory (ROM) or Electrically-Erasable Programmable ROM (EEPROM)), and a data storage device 1518, which can communicate with each other via a bus 1508.

Processing device 1502 can be provided by one or more processors such as a general purpose processor (such as, for example, a Complex Instruction Set Computing (CISC) microprocessor, a Reduced Instruction Set Computing (RISC) microprocessor, a

Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 1500 can further include a network interface device 1522 (e.g., coupled to network 1574). Computer system 1500 also can include a video display unit 1510 (e.g., an LCD), an alphanumeric input device 1512 (e.g., a keyboard), a cursor control device 1514 (e.g., a mouse), and a signal generation device 1520.

In some implementations, data storage device 1518 can include a non-transitory computer-readable storage medium 1524 on which can store instructions 1526 encoding any one or more of the methods or functions described herein, including instructions encoding components of FIG. 1 (e.g., expense manager 122, application 114, etc.) and for implementing methods described herein.

Instructions 1526 can also reside, completely or partially, within volatile memory 1504 and/or within processing device 1502 during execution thereof by computer system 1500, hence, volatile memory 1504 and processing device 1502 can also constitute machine-readable storage media.

While computer-readable storage medium 1524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method, comprising:
obtaining, by a processor, a data stream from a camera of a client device;
identifying an object in the data stream;
performing one or more operations to crop the object from background data of the data stream; and
presenting, on a user interface of the client device, a cropped version of the object.

2. The method of claim 1, further comprising:
performing one or more operations to change an orientation of the cropped version of the object.

3. The method of claim 1, further comprising:
displaying an overlay on the cropped version of the object, wherein the overlay comprises data identified based on the object.

4. The method of claim 1, wherein the object comprises one or more of a receipt, an invoice, or a document.

5. The method of claim 1, wherein the cropped version of the object is presented in real time or near real time.

6. The method of claim 1, further comprising:
performing a shape-based cropping technique to crop the object in the data stream.

7. The method of claim 1, further comprising:
performing a depth-based cropping technique to crop the object in the data stream.

8. A system, comprising:
a memory device; and
a processing device, operatively coupled to the memory device, to perform operations comprising:
obtaining, by a processor, a data stream from a camera of a client device;
identifying an object in the data stream;
performing one or more operations to crop the object from background data of the data stream; and
presenting, on a user interface of the client device, a cropped version of the object.

9. The system of claim 8, wherein the operations further comprise:
performing one or more operations to change an orientation of the cropped version of the object.

10. The system of claim 8, wherein the operations further comprise:
displaying an overlay on the cropped version of the object, wherein the overlay comprises data identified based on the object.

11. The system of claim 8, wherein the object comprises one or more of a receipt, an invoice, or a document.

12. The system of claim 8, wherein the cropped version of the object is presented in real time or near real time.

13. The system of claim 8, wherein the operations further comprise:
performing a shape-based cropping technique to crop the object in the data stream.

14. The system of claim 8, wherein the operations further comprise:
performing a depth-based cropping technique to crop the object in the data stream.

15. A non-transitory computer readable storage medium comprising instructions for a server that, when executed by a processing device, cause the processing device to perform operations comprising:
obtaining, by a processor, a data stream from a camera of a client device;
identifying an object in the data stream;
performing one or more operations to crop the object from background data of the data stream; and
presenting, on a user interface of the client device, a cropped version of the object.

16. The non-transitory computer readable storage medium of claim 15, wherein the operations further comprise:
performing one or more operations to change an orientation of the cropped version of the object.

17. The non-transitory computer readable storage medium of claim 15, wherein the operations further comprise:
displaying an overlay on the cropped version of the object, wherein the overlay comprises data identified based on the object.

18. The non-transitory computer readable storage medium of claim 17, wherein the object comprises one or more of a receipt, an invoice, or a document.

19. The non-transitory computer readable storage medium of claim 15, wherein the cropped version of the object is presented in real time or near real time.

20. The non-transitory computer readable storage medium of claim 15, wherein the operations further comprise:
performing at least one of a shape-based cropping technique or a depth-based cropping technique to crop the object in the data stream.
